(19) United States
(12) Patent Application Publication
(10) Pub. No.: US 2022/0057078 A1
(43) Pub. Date: Feb. 24, 2022

(54) Multifunctional Illumination and Entertainment Device

(71) Applicant: Ettaree Reed, Cordova, SC (US)

(72) Inventor: Ettaree Reed, Cordova, SC (US)

(21) Appl. No.: 17/399,133

(22) Filed: Aug. 11, 2021

Related U.S. Application Data
(60) Provisional application No. 63/069,095, filed on Aug. 23, 2020.

(51) Int. Cl. F21V 33/00; F21V 23/02; F21V 23/00; G16Y 10/75

(52) U.S. Cl. CPC F21V 33/0056; G16Y 10/75; F21V 23/003; F21V 23/02

(57) ABSTRACT

The present invention relates to a multifunctional illumination device. The lamp device includes an integrated audio system including an AM/FM radio, and a CD or music player along with an illumination module. The device has control buttons on a base member and a connected remote control for managing operations of the illumination device. An integrated speaker plays music played via the AM/FM radio, CD player or a removably attached USB stick. The illumination device also has a small storage area to store CDs and other personal items.

### CROSS-REFERENCE TO RELATED APPLICATION

The present application claims priority to, and the benefit of, U.S. Provisional Application No. 63/069,095, which was filed on Aug. 23, 2020 and is incorporated herein by reference in its entirety.

### FIELD OF THE INVENTION

The present invention relates generally to the field of multifunctional personal convenience devices. More specifically, the present invention relates to a multipurpose illumination and entertainment device featuring a table lamp, a radio and a CD player. The multipurpose illumination device can be used for listening to music using the CD player or radio system integrated into the lamp, and illumination for reading books or working on office under the lamp light. The CD player or radio can work while the table lamp is in operation, thereby allowing the individuals to use the lamp for multiple functions. The lamp can be operated using a remote control device when the user is at a distance or can be operated using control buttons or other settings on the lamp when the user is in close proximity to the lamp device. The multipurpose lamp of the present invention eliminates the need to use multiple devices such as radio systems, music systems, lamp devices and more to fulfil the needs of the users. Additionally, the multipurpose lamp can also be wirelessly connected to an electronic device such as a smartphone to play music as per the desires of the user. Accordingly, this disclosure makes specific reference thereto. Nonetheless, it is to be appreciated that aspects of the present invention are also equally applicable to other like applications, devices and methods of manufacture.

### BACKGROUND OF THE INVENTION

By way of background, lighting or illumination devices such as lamps are commonly found in every home, wherein the lamps or illumination devices are used for softly illuminating a room when daylight fades. Lamps are also used while reading books, studying, working at night and for providing general illumination for a room. A lamp such as a table lamp or a night lamp typically has an illumination source of light (bulb or LED) inside a lamp shade and is connected to a power supply source for operating the lamp. Further, other kinds of LED lamps are also available in the market.

Further, illuminating lighting devices have been developed to fulfil the needs of various individuals. As such, individuals can set different colors of light in the bulbs, set the light illumination level, set the timing of illumination, and more. However, standard lamps are only used for offering aesthetic or necessary illumination in rooms. Some individuals may enjoy listening to music while reading in bed, working in an office, and in various other environments. To listen to music, people are required to own other devices such as radio systems, CD players, headphones and other similar music playing devices. However, individuals may lack access to a radio or a CD player. Further, to use CD players individuals must also keep a CD organizer or storage box to manage multiple CDs for said CD player, wherein CD storage box or organizer may occupy some additional space in the room. As such, keeping multiple devices such as a lamp, a radio, a CD player, a CD organizer or storage box, headphones and more can occupy a large amount of space within a room.

Additionally, it may be difficult for individuals to operate and manage multiple devices such as lamp, CD player or radio, CD organizer, headphones and other items at the same time while reading some books, studying, working in the office or just relaxing. As such, managing power supplies to multiple devices and operating said devices can be quite difficult and frustrating, as it shifts the focus of the individuals from their work.

Therefore, there exists a long-felt need in the art for an improved illumination device that also has various other functions. There is also a long-felt need in the art for a multipurpose illumination device that allows an individual to listen and enjoy music while reading books, studying, or working under the lamp light. Additionally, there is a long-felt need in the art for a multipurpose illumination device that eliminates the need to own separate radio systems, CD players, and other devices to listen music or engage in other activities. Further, there is a long-felt need in the art for a multipurpose illumination device that allows the users to store CDs and eliminates the need to have a separate CD storage box to organize them. Finally, there is a long-felt need in the art for a multipurpose illumination device that combines various devices and features into a single device when reading in bed, relaxing, working in an office, or engaging in other activities.

The subject matter disclosed and claimed herein, in one embodiment thereof, comprises a multipurpose illumination device that has an integrated audio playing system that allows an individual to listen to music while also using the illuminating source. The illumination device further includes a base that is adapted to support a vertical connecting arm, wherein the arm electrically connects the illumination source to the base. The base also has a housing that includes a CD player, a frequency modulation (FM) receiver, a small storage space for storing CDs, an integrated speaker, an AC-DC converter, and a power cord that extends from the base to connect to a regular power supply wherein the electrical power from the power cord is further converted to a desired DC by the AC-DC converter and the converted DC is used for illuminating the lamp. The AC from the power cord is further used for providing power to the CD player and FM receiver allowing a user to listen music, audio books, and the like using the integrated speaker of the illumination device. A cover for the illumination device can also be integrated into the device to eliminate glare of the lamp in eyes of a user, or provide other illumination aesthetics.

In this manner, the novel multipurpose illumination device of the present invention accomplishes all of the forgoing objectives and provides an easy and convenient solution to listen to music and receive illumination while reading books, working, studying, relaxing or engaging in other activities. The device is also user friendly, as it combines multiple devices into a single unit for the convenience of the user and eliminates the need to manage or operate multiple devices while working, studying or relaxing. The multipurpose illumination device also ensures an individual is able to properly focus on their work or enjoy relaxing. Additionally, the device is compact and can be easily set into any corner of the room, table, or desk and can be operated remotely for the convenience of the user.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose an illumination device. The device has an integrated audio player system allowing individuals to listen to music, books, and other recordings. The device further includes a base that is adapted to support a vertical connecting arm. The vertical connecting arm electrically connects an illumination device to the base, wherein the base has a housing that includes a CD player, a frequency modulation (FM) receiver, a small storage space for storing CDs, an integrated speaker, an AC-DC converter, and a power cord that extends from the base to connect to a regular power supply. Further, the electrical power from the power cord is converted to a desired DC by said AC-DC converter and the converted DC is used for illuminating the lamp feature of the device. The AC from the power cord is also used for providing power to the CD player and FM receiver, which allows an individual to listen music using the integrated speaker contained within housing. A lamp cover can be integrated to the lamp device to eliminate glare of the lamp in eyes of a user. Further, the device may have an integrated temperature display showing a current ambient temperature and an alarm device which can be set to a time value using an integrated clock.

In a further embodiment of the present invention, a multipurpose illumination device is disclosed that includes a flexible connecting arm, a base supporting bottom of the flexible connecting arm, a LED lamp disposed on top of the flexible connecting arm, and wherein the connecting arm couples the LED lamp with the base through an electrical wire. The base also includes a music player which has a slit for inserting a compact disk, a frequency modulation (FM) receiver, an integrated speaker, a short range communication module, an integrated battery, and a power cord that extends from the base. The surface of the base further has a control button for activating or deactivating the light fixture, a FM control button to turn on and off the FM receiver, a lamp control button for switching on or off the LED lamp, a volume control button for adjusting volume of the integrated speaker, and a remote control configured to control operations of the light fixture. The operations of the light fixture include one or more of activating or deactivating the light fixture, turning on and off the FM receiver, turning on and off the music player, switching on or off the LED lamp, and adjusting volume of said inbuilt speaker.

In another embodiment of the present invention, a multipurpose illumination device is disclosed that includes a base member and a dimmable light module which is disposed on the base member. The base member further includes an AM/FM radio, a CD player, a storage space to store CDs, a USB port that is configured to receive a USB device, and a transformer to convert input electric supply to desired DC supply for the dimmable light module. The input electric power supply provides power to the AM/FM radio and the CD player and the electric power supply is provided by an integrated power cord. A remote control is also provided to adjust the illumination of the dimmable light module using a short-range communication protocol.

In differing embodiments, the light fixture can be configured as a table lamp or a floor lamp. The light fixture can be used for desk, floor, landscape, ground, table, bed, moving table, bed side table, or any flat surface. The light module of the light fixture can be an incandescent lamp, an ultraviolet lamp, or LED light. The light module or lamp can be one of screw in or snap-in or fit tight LED bulb, CFL, Florescent tube, LED tube, EL, OEL, Organic EL elements or light panel or light piece. Further, the light module can be dimmable or non-dimmable.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multipurpose illumination device of the present invention in accordance with the disclosed structure;

FIG. 2 provides a block diagram showing internal components of one potential embodiment of a multipurpose illumination device of the present invention in accordance with the disclosed specification;

FIG. 3 shows a schematic diagram of wireless connection of one potential embodiment of a multipurpose illumination device of the present invention with a remote control in accordance with the disclosed description;

FIG. 4 depicts a schematic diagram of a Bluetooth connection of one potential embodiment of a multipurpose illumination device of the present invention with a companion smartphone application installed in an electronic smart device in accordance with the disclosed structure;

FIG. 5 provides a perspective view of another potential embodiment of a multipurpose illumination device of the present invention in accordance with the disclosed specification; and

FIG. 6 illustrates one potential embodiment of a multipurpose illumination device of the present invention that is IoT enabled in accordance with the disclosed specification.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved illumination device that also has various other functions and allows an individual to listen and enjoy music while reading books, studying, or working under the lamp light. Additionally, there is a long-felt need in the art for a multipurpose illumination device that eliminates the need to own separate radio systems, CD players, and other devices to listen music or engage in other activities. Further, there is a long-felt need in the art for a multipurpose illumination device that allows the users to store CDs and eliminates the need to have a separate CD storage box to organize them. Finally, there is a long-felt need in the art for a multipurpose illumination device that combines various devices and features into a single device when reading in bed, relaxing, working in an office, or engaging in other activities.

The present invention, in one exemplary embodiment, a multipurpose illumination device is disclosed. The device includes a base member having a housing with a plurality of walls extending upwardly from a flat base with one or more of the wall having an opening and a dimmable light module in which the dimmable light module is disposed on the exterior surface of the base member. The base member further includes an AM/FM radio, a CD player, a storage space to store CDs, a USB port configured to receive a USB device, a transformer to convert input electric supply to desired DC supply for dimmable light module. The input electric power supply provides power to the AM/FM radio and the CD player and the electric power supply is provided by an integrated power cord. The device can be controlled using a remote control 302 or a paired electronic device in order to control the illumination of the dimmable light module using a short-range communication protocol and operate CD player, AM/FM radio, speakers and more.

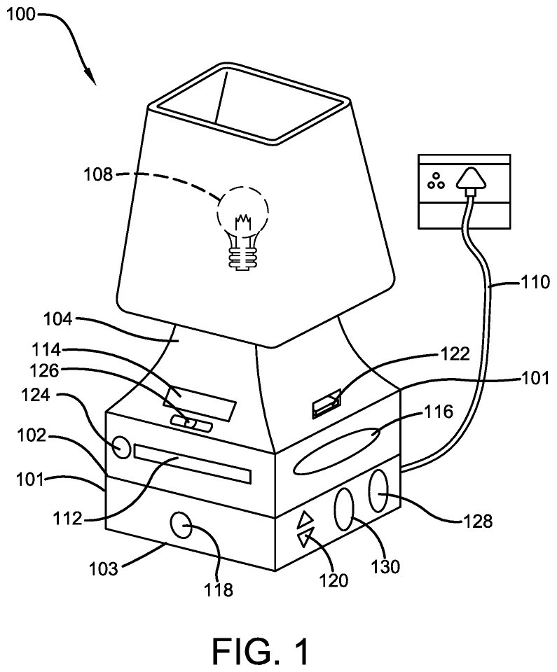

Referring initially to the drawings, FIG. 1 illustrates a perspective view of one potential embodiment of a multipurpose illumination device 100 of the present invention in accordance with the disclosed structure. The illumination device 100 of the present invention is a multipurpose lamp and audio player system that provides convenience when an individual is reading in bed, working in an office, relaxing or otherwise engaging in various other past time activities. The illumination device 100 has a base 102 which is placed on a floor, table, or other flat surface. The base 102 includes a housing having a series of walls 101 extending upwardly from a flat surface 103. The base 102 supports a connecting member 104 that has a light module 108 at top end. The light module 108 can be one of an incandescent lamp, an ultraviolet lamp or LED, a screw in or snap-in or fit tight LED bulb, CFL, Florescent tube, LED tube, EL, OEL, Organic EL elements or any other light panel or light piece known in the art. The light module 108 is connected to the base 102 through an internal wire passing through the connecting member 104. A designer light cover or other lamp shade 106 is used for preventing glare caused by the light module 108 and the light cover 106 covers the light module 108. The light module 108 and cover 106 are positioned above the base 102 and housing. The cover 106 can be of any fabric or a translucent plastic and is open from the top.

The base 102 also contains an internal wired circuit for connecting components housed within the base member 102. A compact disc (CD) player 112 is integrated within the base 102 and has an opening 113 for inserting a disc for playing music or other audio recording from a CD inserted in the CD player 112. A CD player control button 124 is allowed to play music or other recording using the integrated CD player 112. The base 102 has a small storage area 118 for storage of CDs, USB or any other small personal items. A USB port 122 may also be present in a side surface of connecting member 104 or the base 102 for receiving a USB flash drive which can have songs stored in it. There may also be additional internal components present within the base member 102 that allows a user to control the functions of the device 100 from a remote control 302. In other embodiments of the present invention, a temperature sensor 212 and a timer or timing circuit 214 can also be present in addition to above-described components.

For playing music or other recorded media, an integrated amplitude modulator (AM) and frequency modulator (FM) 114 receives broadcasted music. A user can also receive broadcasted podcasts using AM/FM modulator 114. An AM/FM control button 126 is used for operating the AM/FM receiver 114. The control button 126 can switch the modulator 114 from AM to FM and vice versa. The base 102 has an integrated speaker 116 formed as an opening in a wall 101 for playing out music or any audio of the CD player 112, USB flash drive inserted into the USB port 122, or the AM/FM 114 radio feature. A volume control button 120 is disposed on the base 102 for adjusting volume of the speaker 116 as per the preferences of a user.

A power button 128 is also disposed for turning ON and OFF the light module 108 and an intensity control button 130 is used for adjusting the intensity of the light module 108. In an embodiment wherein the light module 108 is a smart bulb, the color can also be changed using the control button 130. To provide power to the device 100, a power cord 110 extends from the base 102 is inserted into a regular 120V/240V power outlet.

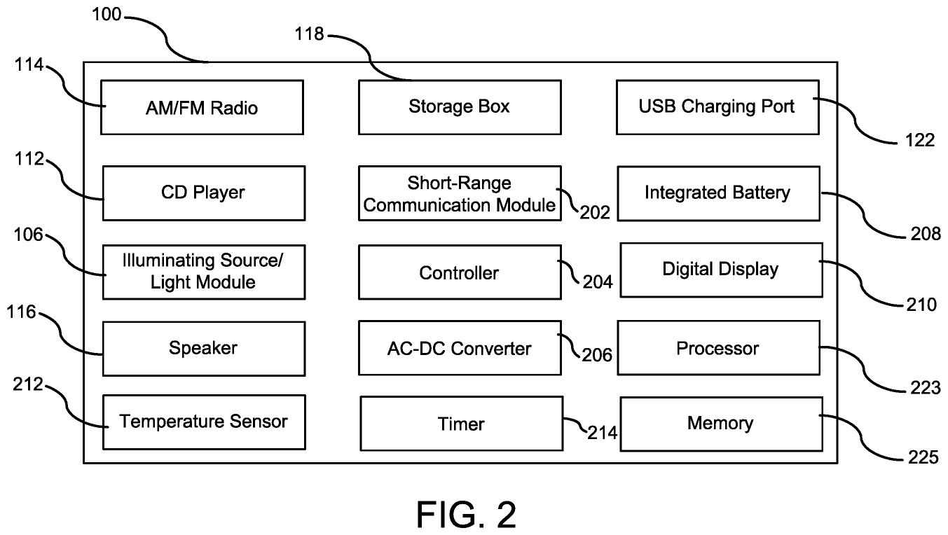

FIG. 2 provides a block diagram showing internal components of one potential embodiment of a multipurpose illumination device 100 of the present invention in accordance with the disclosed specification. It should be noted that various embodiments of the present invention have all or a subset of the components described herein as per the preferences during the manufacturing process and options preferred by individuals. As shown in FIG. 2, the multipurpose illumination device 100 has an AM/FM radio component or receiver 114 that receives music, news, podcasts and the like from broadcasted radio frequencies. The AM/FM radio component 114 is electrically connected to the speaker 116 via an electrical line and is also electrically connected to an integrated battery 208 or direct power supply of the power cord 128. The illumination device 100 has a CD player 112 that plays music or audio stored in a compact disk. The CD player 112 can have a repeat and skip function. The device 100 has an illuminating source or light module 108 that is operable to provide illumination. As stated earlier, the illuminating source 106 can be one of an incandescent lamp, an ultraviolet lamp or LED, screw in or snap-in or fit tight LED bulb, CFL, Florescent tube, LED tube, EL, OEL, Organic EL elements or any other light panel or light piece. The device 100 has a storage box 118 which enables user to store several CDs and other items, wherein the storage box 118 can be accessed via a narrow horizontal door. A processor 223 may also be provided to receive and process information received from the various modules such that an individual may have retained settings that are saved in a memory 225. For example, the light module 108 may be controlled by the processor 223 so that a setting may be stored and the dimmable module 108 is illuminated to that particular level. The memory 225 may also be provided in order to allow an individual to program different illumination settings as well as playback information for other recordings. The device 100 has an integrated short-range communication module 202 that allows a user to control settings of the illumination device 100 and its functions using a remote control 302 via a short-range communication channel such as Bluetooth, Infrared waves, ZigBee, and other such type of communication medium. Using the integrated short-range communication module 202, a wireless communication channel can be set up by the device 100. The illumination device 100 also has a controller 204 for receiving signals generated by a remote control 302 or a mobile device using a short-range communication channel for controlling the operation of the device 100.

The illumination device 100 also has an AC-DC converter 206 which converts the regular power supply and the electrical power from the power cord to a desired DC is used for illuminating the illumination device 100 and one or more other components of the device 100. The AC-DC converter 206 can additionally regulate the regular power supply and the electrical power from the power cord providing power to the CD player 112 and AM/FM receiver 114. The illumination device 100 also has a USB port 122 which allow for the charging of the integrated battery 208 and also provides an external source of music or other audio recording or media in the form of a USB flash drive. The illumination device 100 can have a digital display 210 positioned on the base for displaying current date, time, and ambient temperature. The device 100 also has a temperature sensor 212 such as thermocouples, or thermistors which are used for measuring real time temperature. The device 100 may also have a timer or clock 214 that provides the user with the real time clock reading on-demand. Further, it should be noted that all the electronic components of the illumination device 100 are connected through one or more wired circuits within the device 100. Said wired circuits are further insulated and protected from any damage.

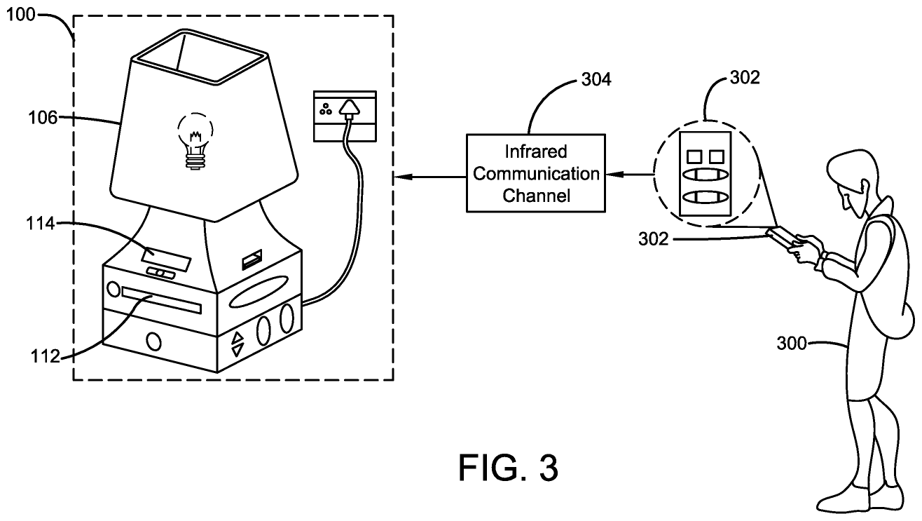

FIG. 3 shows a schematic diagram of wireless connection of one potential embodiment of a multipurpose illumination device 100 of the present invention with a remote control 302 in accordance with the disclosed description. A user 300 can control and access the features of the illumination device 100 using a remote-control device 302 via short-range communication channel 304 such as an infrared (IR) or RFID channel. The infrared signal between the remote control 302 and the multifunctional illumination device 100 via short-range communication channel 304 comprises pulses of infrared light which are invisible to the human eye. The remote-control device 302 has an IR transmitter that sends out an instruction in form of a stream of pulses of infrared light when the user 300 presses a button on the remote control 302. The short-range communication module 202 further recognizes the pattern and causes the illumination device 100 to respond to the received instructions. The remote-control device 302 generates the pulses of infrared light that travels to the multifunctional illumination device 100 using the short-range communication channel 304 which enables the user to access and control the feature such as AM/FM radio 114, CD player 112, and illuminating source 106 of the multifunctional illumination device 100.

The remote control device 302 also enables the individual to increase or decrease the volume of the audio from the speaker of the device 100. The remote control device 302 enables the individual to switch ON/OFF the table device 100 and also allows the user to adjust the intensity of the illuminating source 106 of the device 100. The remote control device 302 further enables an individual to skip or resume the music of the CD player 112, or switch the AM/FM radio 114 from the AM mode of operation to the FM mode of operation.

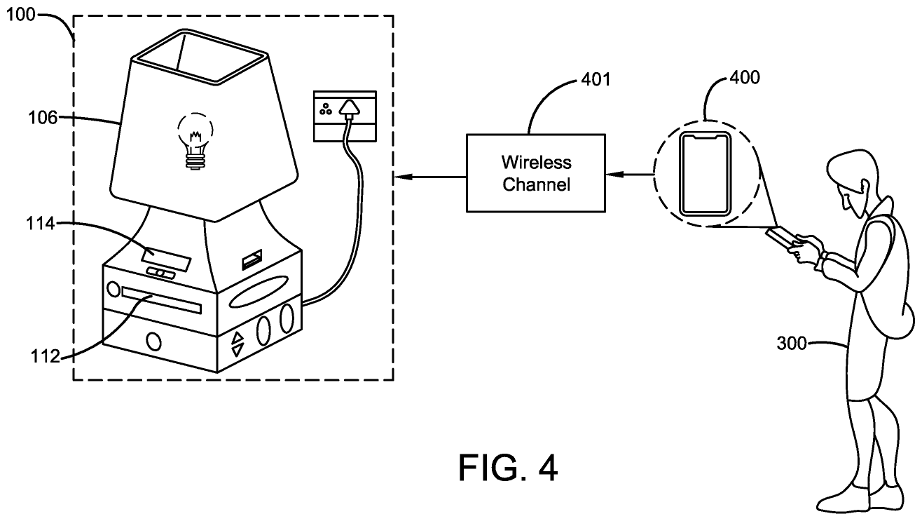

FIG. 4 depicts a schematic diagram of a Bluetooth connection of one potential embodiment of a multipurpose illumination device 100 of the present invention with a companion smartphone application installed in an electronic smart device in accordance with the disclosed structure. As shown in FIG. 4, a user 300 can connect the table lamp 100 to one or more nearby smartphone devices 400 using a wireless communication medium 401 such as Bluetooth, Wi-Fi or any other similar wireless technology. The smartphone device 400 has a companion software application which enables the user 300 to access and control the features such as AM/FM radio 114, CD player 112, and illuminating source 106 of the lamp 100. A user 300 can further increase or decrease the volume of the audio from the speaker of the device 100, switch ON/OFF the table device 100, adjust the intensity of the illuminating source 106 of the device 100, skip or resume playing music of the CD player 112, or switch the AM/FM radio 114 from the AM mode of operation to the FM mode of operation.

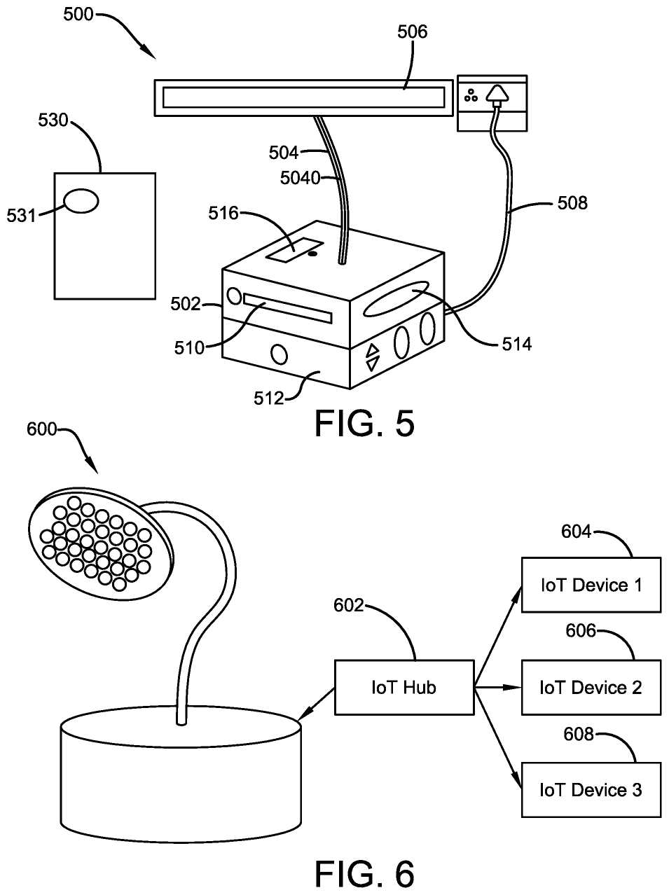

FIG. 5 illustrates a perspective view of another embodiment 500 of the multifunctional table lamp 100 of the present invention in accordance with the disclosed specification. In said embodiment 500, the device 500 includes a flexible connecting member 504 extending from the base 502. A light module 506 is in the form of a LED tube and is connected through a wire 5040 passing through the flexible connecting member 504. The base 502 also has an AM/FM transceiver 516, a CD player/music player 510, an integrated speaker 514 and a storage space 512. It should be noted that these components work and can be controlled in a manner similar to the other embodiments of the present invention. A power cord 508 plugged into a regular power supply provides power to the multifunctional lamp and its components for the operation.

FIG. 6 illustrates one potential embodiment of a multipurpose illumination device 100 of the present invention that is IoT enabled in accordance with the disclosed specification. In the present embodiment 600, the device 100 is configured to be connected to an IoT hub 602. A wireless home network such as a home Wi-Fi network is used for making a connection with the IoT hub 602. The IoT hub 602 is connected to other IoT devices or sensors 604, 606, 608 to receive information such as motion information, door information, information on nearby items 530 which have been provided with RFID tags 531 or combinations thereof. Information received from the sensors is used by IoT hub 602 to relay an instruction to the IoT enabled device 600. For example, the instruction can be of automatic switching on the LED or integrated CD player when the IoT hub 602 determines that a user is about to enter into the room at a specified time based on the IoT sensors information. In addition, the RFID tagged devices 530 can be used to play pre-set music or a previously determined illumination level.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose illumination device”, “illumination device” and “device” are interchangeable and refer to the multipurpose illumination device 100 of the present invention.

Notwithstanding the forgoing, the multipurpose illumination device 100, 500, 600 of the present invention can be of any suitable size and configuration as is known in the art without affecting the overall concept of the invention, provided that it accomplishes the above stated objectives. One of ordinary skill in the art will appreciate that the size, configuration, and material of the multipurpose illumination device 100, 500, 600 as shown in the FIGS. are for illustrative purposes only, and that many other sizes and shapes of the multipurpose illumination device 100, 500, 600 are well within the scope of the present disclosure. Although the dimensions of the multipurpose illumination device 100, 500, 600 are important design parameters for user convenience, the multipurpose illumination device 100, 500, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose illumination device comprising:
a housing having a flat surface and walls extending upwardly from the flat surface with at least one wall having an opening;
an illumination feature positioned above the housing, wherein the illumination feature includes a light module;
a storage area within the housing; and
a speaker disposed within the opening.

2. The multipurpose illumination device as recited in claim 1, wherein the device plays music through the speaker.

3. The multipurpose illumination device as recited in claim 1, wherein the device is comprised of an AM/FM radio or a CD player.

4. The multipurpose illumination device as recited in claim 1, wherein the device is comprised of both a AM/FM radio and CD player.

5. The multipurpose illumination device as recited in claim 1 further comprising a temperature sensor and a timer.

6. The multipurpose illumination device as recited in claim 1 further comprising a memory for pre-set illumination and playback settings.

7. The multipurpose illumination device as recited in claim 6, further comprising a processor connected to the memory to store and retrieve pre-set settings.

8. The multipurpose illumination device as recited in claim 1 further comprising a digital display for showing date, time, and temperature.

9. The multipurpose illumination device as recited in claim 1 further comprising a power source contained in the housing.

10. The multipurpose illumination device as recited in claim 9, wherein the power source is an integrated battery or an AD/DC connected source.

11. A multipurpose illumination device comprising:
a base for supporting an illumination module;
a CD player and an AM/FM radio contained within the base;
a speaker connected to each of the AM/FM radio and the CD player, wherein the speaker is disposed in an opening in a wall of the base;
a digital display provided on a wall of the base;
a processor connected to a memory module contained within the base; and
a wireless transceiver disposed within the base.

12. The multipurpose illumination device as recited in claim 11, wherein the wireless transceiver can connect to a smart phone.

13. The multipurpose illumination device as recited in claim 11, wherein the digital display provides information relating to time, temperature, and date.

14. The multipurpose illumination device as recited in claim 11, wherein the wireless transceiver connects with a smart phone and/or remote control.

15. The multipurpose illumination device as recited in claim 11, wherein the illumination module has a dimmable setting.

16. The multipurpose illumination device as recited in claim 15, wherein the illumination module is controlled by the processor.

17. The multipurpose illumination device as recited in claim 16, wherein the processor is connected to a memory.

18. A multipurpose illumination device comprising:
an illumination module having a dimmable setting;
a source for playing music through a speaker, the source including an AM/FM radio and a CD player;
a base having a housing with the housing having walls and a flat surface, at least one of the walls having an opening;
a processor connected to a memory for storing pre-established settings; and
a digital display for displaying date, time and temperature and a wireless transceiver for remotely playing the source and activating the illumination module.

19. The multipurpose illumination device as recited in claim 18, wherein the wireless transceiver is connected to a IoT network.

20. The multipurpose illumination device as recited in claim 19 further comprising an RFID enabled device which connects to the IoT network and activates one of the illumination module or source.
